(19) United States
(12) Patent Application Publication
(10) Pub. No.: US 2026/0087741 A1
(43) Pub. Date: Mar. 26, 2026

(54) Method for Automatic Creation of 3D Models for Dental and Orthodontic Use

(71) Applicant: CADFLOW Inc., Huntington Beach, CA (US)

(72) Inventors: Ryan Goy, Redondo Beach, CA (US); Vijay Dhaka, Huntington Beach, CA (US)

(21) Appl. No.: 19/344,132

(22) Filed: Sep. 29, 2025

Related U.S. Application Data
(63) Continuation-in-part of application No. 17/916,278, now Pat. No. 12,450,848.
(60) Provisional application No. 63/003,568, filed on Apr. 1, 2020.

(51) Int. Cl. G06T 17/20; A61C 7/00; G06T 5/70; G06T 7/73

(52) U.S. Cl. CPC G06T 17/20; A61C 7/002; G06T 5/70; G06T 7/75; G06T 2200/04; G06T 2207/30036; G06T 2210/41; G06T 2210/56

(57) ABSTRACT

A system and method that is a web based application for creating and managing 3D models used in orthodontic laboratory prescriptions within a dental clinic or lab. The method includes automatically detecting and removing any appliances contained within the 3D image file. After the appliances have been removed, the system then automatically infers new image data that is calculated to approximate the surface of the tooth disposed beneath the deleted appliance in order to create a clean, second 3D image. The method may further automatically refine the second 3D image of the patient's teeth or delete any artifacts which remain after creation of the second 3D image. The second 3D image may then be used as the basis on which to change the patient's orthodontic or dental prescription.

### CROSS-REFERENCE TO RELATED APPLICATIONS

This patent application claims priority to U.S. patent application Ser. No. 17/916,278, filed on Sep. 30, 2022, which is incorporated by reference.

### BACKGROUND

### Field of the Technology

The invention relates to the field of manufacturing customized orthodontic and dental appliances, and in particular to the automatic editing of 3D images used in creating an orthodontic or dental prescription for a patient.

### Description of the Prior Art

In the orthodontic office and laboratory, prescriptions which were once prepared manually with resin impressions or molds are more and more being carried out in a digital workspace. Instead of creating a physical mold of the patient's teeth which can be uncomfortable for the patient or time consuming, the patient simply scans their mouth and teeth via an intraoral digital scan.

Once the patient has had their teeth digitally scanned, the orthodontist may take data from the scan to create a 3D image which corresponds to the patient's teeth. Since each prescription is unique to each patient and may be made up of multiple parts or appliances with very specific designs, the 3D image is manipulated accordingly to add or remove any appliances which may be necessary to carry out the orthodontist's new or updated prescription. Once complete, specifications corresponding to the appliances added to the 3D image and the 3D image itself are sent out to a lab for manufacture. Use of a 3D model allows the orthodontist to virtually apply or reapply different appliances to the patient's teeth without having to use a physical casting of the patient's teeth, thus dramatically cutting down on the time and expense required for preparing a patient's orthodontic prescription.

A problem develops however for those patients who are already wearing orthodontic appliances including brackets for braces who then undergo an intraoral scan to have their prescription altered or changed. The resulting 3D image of the patient's teeth therefore inherently includes these pre-existing appliances, making it difficult if not impossible for the orthodontist to apply new orthodontic appliances or adjust preexisting ones within the 3D image.

Additionally, while 3D image editing tools exist which could potentially remove the brackets from the initial 3D image, these tools are quite labor intensive and can require multiple hours to edit for even a single patient. Specifically, many 3D image tools require a user to manually select the image object to be removed, remove the object, and then complete any additional image editing. Furthermore many of these same 3D image editing tools lack the capability to reconstruct the surface of the teeth after the removal of the brackets, thereby resulting in a “hole” or blank spot where no image data exists.

What is needed is a method modifying 3D images, such as removing orthodontic appliances including brackets from 3D images, to assist in the design and or manufacture of dental prosthetics. The method should be simple and easy to use as well as fast to implement by being largely automatic and requiring little to no input from a user.

### BRIEF SUMMARY

The illustrated embodiments of the invention include within their scope a method of creating and manipulating a 3D model which may be subsequently used when creating an orthodontic or dental prescription. The method includes uploading a first 3D image to an uploads database, detecting image data corresponding to at least one appliance within the first 3D image, generating a predicted displacement vector related to the image data corresponding to the at least one appliance, inferring 3D image data calculated to approximate the surface of a tooth without the image data corresponding to the at least one appliance to create a second 3D image, and saving the second 3D image to a processed database. The steps of detecting the image data, generating the predicted displacement vector, and inferring 3D image data calculated to approximate the surface of the tooth to create a second 3D image are automatically performed in sequence.

In certain embodiments, uploading the first 3D image to an uploads database includes providing a first 3D mesh corresponding to the first 3D image. Detecting image data corresponding to the at least one appliance within the first 3D image may include converting the first 3D mesh into a first point cloud comprising a plurality of points and a plurality of normal vectors. Generating the predicted displacement vector related to the image data corresponding to the at least one appliance may include generating a predicted displacement vector for each of the plurality of points and each of the plurality of normal vectors of the first point cloud. Inferring 3D image data calculated to approximate the surface of the tooth without the image data corresponding to the at least one appliance to create the second 3D image commences only when at least one of the predicted displacement vectors comprises a non-zero value.

In certain embodiments, the method includes terminating the method when each of the predicted displacement vectors comprise a zero value.

In certain embodiments, inferring 3D image data calculated to approximate the surface of the tooth without the image data corresponding to the at least one appliance to create the second 3D image may include adding the predicted displacement vectors to the first point cloud to create a second point cloud.

In certain embodiments, the method may also include removing any artifacts from the second point cloud.

In certain embodiments, the metho may also include converting the second point cloud to the second 3D image.

In certain embodiments, saving the second 3D image to the processed database may be performed automatically in sequence after inferring the 3D image data calculated to approximate the surface of the tooth without the image data corresponding to the at least one appliance.

In certain embodiments, removing any artifacts from the second point cloud includes defining an intersection between the second point cloud corresponding to the surface of the tooth without the image data corresponding to the at least one appliance and image data corresponding to a gumline of the patient within the second point cloud.

In certain embodiments, removing any artifacts from the second point cloud may include smoothening at least a portion of the second point cloud corresponding to the surface of the tooth without the image data corresponding to the at least one appliance.

In certain embodiments, detecting the image data corresponding to the at least one appliance within the first 3D image may include detecting image data corresponding to an orthodontic bracket.

In certain embodiments, the method may include transmitting metadata related to the first 3D image to a server in communication with the uploads database and the processed database.

In certain embodiments, the method also includes sending the first 3D image from the server to a queue before detecting image data corresponding to at least one appliance within the first 3D image.

In certain embodiments, uploading the first 3D image to the uploads database may include automatically saving the first 3D image to a file storage within the uploads database.

In certain embodiments, uploading the first 3D image to the uploads database may include uploading a first STL file comprising the first 3D image.

In certain embodiments, saving the second 3D image to the processed database may include saving the second 3D image to a file storage within the processed database.

In certain embodiments, the method may also include detecting image data corresponding to a gumline within the first 3D image, and trimming the detected image data corresponding to the gumline. Inferring 3D image data calculated to approximate the surface of the tooth without the image data corresponding to the at least one appliance to create a second 3D image may include smoothening the image data corresponding to the gumline. The steps of detecting, trimming, and smoothening the image data corresponding to the gumline within the first 3D image may be automatically performed in sequence.

In certain embodiments, the method may also include building a base to the image data corresponding to the gumline within the first 3D image.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a flow chart illustrating a method for automatic creation of a 3D dental or orthodontic model provided by the current invention.

FIG. 2 is a flow chart illustrating a sub-method for automatic removal of orthodontic appliances from a 3D image provided within the method for automatic creation of a 3D dental or orthodontic model seen in FIG. 1.

FIG. 3 is a flow chart illustrating a sub-method for automatic trimming and basing of a 3D image provided within the method for automatic creation of a 3D dental or orthodontic model seen in FIG. 1.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

The illustrated system and accompanying method relate to a web based application that receives a standard triangle language (STL) image file which has been obtained from an intraoral digital scan or a cone-beam CT scan of a patient's mouth and teeth, or a digital study model service which can come directly from a lab, a doctor, or another web based application for managing prescriptions within a dental clinic, office, or lab. The method allows for orthodontists to manipulate their prescriptions or change prescriptions for patients who are already wearing braces or other orthodontic appliances which comprise brackets or other similar orthodontic components. The system and method provide an algorithm or series of algorithms to automatically detect and displace the surface the presence of any brackets, bands, attachments, wires, or any other orthodontic or dental appliance and directly form a reconstructed tooth without the original appliance. The system and method provide an algorithm or series of algorithms to automatically perform additional functions that assist in the design and manufacture of dental appliances. These additional functions include automatically cleaning the STL file, closing the model, and adding a base in a file format that is print ready or that can be further detailed using CAD software. The image data corresponding to the surface of the teeth beneath the removed appliance is then reconstructed to provide a complete 3D image of the patient's teeth that is free from any appliances.

The current system and method disclosed herein may be a standalone or independent application. For example, the current system and method can be integrated into the platforms disclosed in U.S. Pat. No. 10,299,891, entitled “System and Method for Ordering and Manufacturing Customized Orthodontic Appliances and Product”, filed Mar. 16, 2016, and U.S. application Ser. No. 16/712,362, entitled “System and Method for Ordering and Manufacturing Customized Dental Appliances and the Tracking of Orthodontic Products,” filed Dec. 12, 2019, both of which are incorporated herein by reference in their entirety.

According to certain embodiments, a method to digitally debond brackets from raw intraoral scans using machine learning is provided. For example, a model may receive an intraoral dental scan with or without brackets as input, and digitally debonds the brackets where available. A preprocessing clean up step may be applied to the mesh so that it may then be converted into a point cloud which retains all the information from the original intraoral scan. The machine learning model may be trained to recognize the points of the point cloud that correspond to brackets and then adjust each recognized point with a displacement vector in order to form an inferred surface of the tooth or teeth without brackets. The normal vectors may also be inferred in order to apply a final remeshing algorithm to yield a final mesh without brackets. The machine learning model may be trained on a dataset that includes thousands of before and after physical debonding images or point clouds corresponding to images.

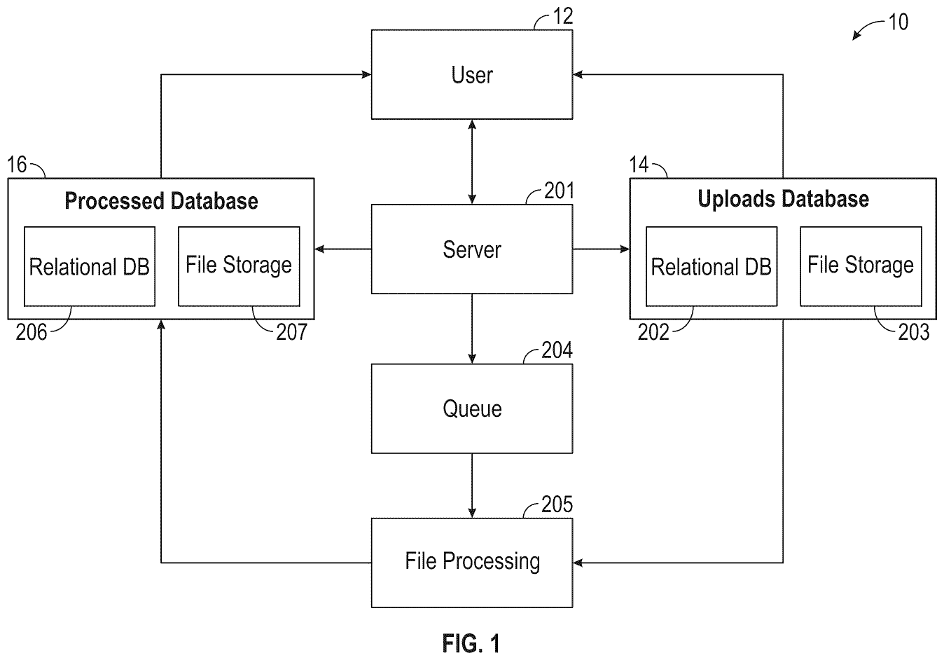

The illustrated system and method 10 can be understood by turning to FIGS. 1-3. A user 12, who may be a dentist, an orthodontist, or a lab technician first performs an intraoral scan of the patient's teeth to produce a standard triangle language (STL) file or other 3D image file. The user 12 begins by transmitting metadata to a server 201 including filename and other parameters and receives a response comprising an upload point to an uploads database 14 which is a web based application which comprises a file storage 203 and a relational database 202 for storing and saving the uploaded STL image file. Upon receipt of the incoming STL image file to database 14, the server 201 sends the uploaded STL image file to a queue 204 where it will await for subsequent editing within the file processing step 205 which utilizes a domain-specific language (DSL) or a native computer language to detect any orthodontic or dental appliances which may be contained within the 3D image and then displaces the corresponding points to form a natural tooth without appliances. A supervised machine learning model is used to create per-point displacement values, which are added to the original point cloud. This machine learning model utilizes the Euclidean coordinates, normal information, as well as surface curvature, and approximates the appearance of the surface of the tooth beneath the now deleted appliance. Next, for those teeth that have had an appliance deleted therefrom, the data processing step 205 includes calculating the curvature of the surface of each tooth and uses the result to approximate the appearance of the surface of the tooth beneath the now deleted appliance. The automatic bracket removal (ABR) process, as defined by the detection of image data which corresponds to an appliance, deletion of the image data which corresponds to the detected appliance, and the reconstruction of the tooth surface disposed beneath the deleted appliance, occurs as soon as the original STL image file is received from the user 12 without any further input on their part. Once the STL file has been automatically edited by the data processing step 205, it is sent to a processed database 16 which is accessible by the user 12. The processed database 16 itself comprises its own corresponding file storage 207 and relational database 206 which are used to store or save the edited STL file. Both the relational database 202 in the uploads database 14 and the relational database 206 in the processed database 16 contain metadata such as processing status and time of upload that can quickly be relayed to the user 12 while the file storage 203 in the uploads database 14 and the file storage 207 in the processed database 16 contain the larger STL image files before and after processing, respectively.

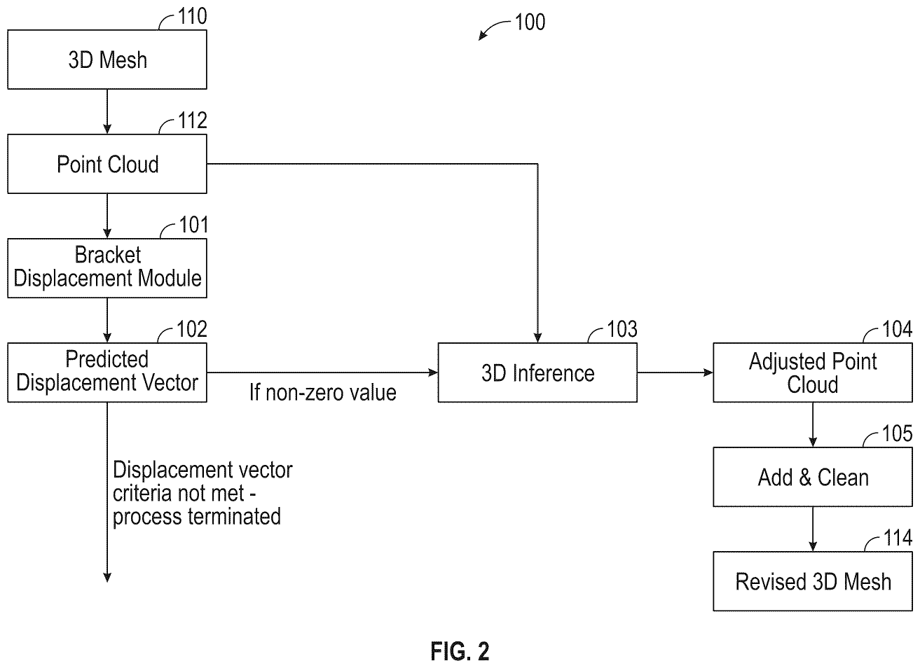

Turn now to the flow chart of FIG. 2 for an overview of the ABR method 100 of the current invention which takes place within the data processing step 205. A STL file which contains one or more 3D meshes 110 is first obtained via an intraoral scan of the patient's mouth and teeth as is known in the art. The 3D mesh 110 includes a rendering of not only the patient's teeth and gum line, but also any brackets or other orthodontic appliances which are currently being used for the patient's orthodontic treatment.

According to certain embodiments, the obtained 3D mesh 110 is first converted into a point cloud 112 which may include set of points and normal vectors corresponding to the 3D mesh 110. The point cloud 112 may be passed into a bracket displacement module 101 as seen in FIG. 2 which automatically generates a predicted displacement vector 102 for each point in the point cloud 112, as well as a new normal vector.

According to certain embodiments, if the displacement vectors are predicted to have a non-zero value for a model, the predicted displacement vectors 102 are added point-wise to the input or first point cloud 112, yielding an adjusted point cloud 104. Specifically, the input cloud 112 and the displacement vectors 102 may undergo 3D inference in step 103 where 3D image data is calculated to approximate the surface of a tooth to create a complete 3D image of the patient's teeth. In certain embodiments, the 3D inference step 103 uses machine learning techniques trained on a dataset of intraoral scans without brackets to create new image data which corresponds to the surface of a tooth without the bracket. The end result is a second, updated, or revised point cloud 104 which has had the image data related to any brackets or other orthodontic appliances effectively and efficiently removed, thereby providing a clean image of the patient's teeth and providing the user a means to easily adjust or change their prescription accordingly. In certain embodiments, any remaining artifacts or miscellaneous image data is deleted from the adjusted point cloud 104 in step 105, thereby producing a clean image that is free from errors which may interfere with any subsequent manipulation by the user. In certain embodiments, the clean, adjusted point cloud 104 may then be re-meshed utilizing the inferred normal vectors to provide a final revised or second 3D mesh 114. In certain embodiments, re-meshing the adjusted point cloud 104 may include removing any overlapping points that were created when the displacement vectors 102 were added to the first point cloud 112. For example, if the first point cloud 112 corresponded to a 3D mesh 110 where brackets with overhanging portions were disposed on the patient's teeth, when the displacement vectors 102 are used to displace the point cloud to an expected surface of the tooth without the bracket, one or more overlapping points may be created. Re-meshing the adjusted point cloud 104 to generate the revised 3D mesh 114 may remove these overlapping points so that a clean 3D image of the patient's teeth without the bracket or any other appliance may be provided.

Conversely, according to certain embodiments, if the bracket displacement module predicts exclusively displacement vectors with a zero value, the threshold criteria has not been met and the ABR method 100 is terminated.

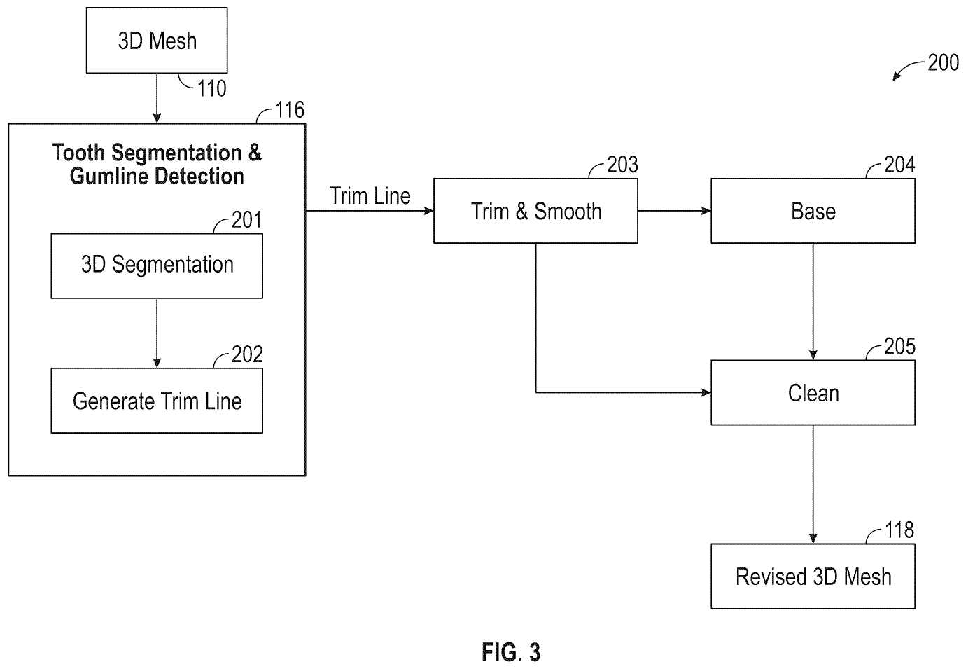

In a related embodiment, turn now to the flow chart of FIG. 3 for an overview of a trim and base method 200 which may take place within the data processing step 205. An STL image file which contains one or more 3D meshes 110 is first obtained via an intraoral scan of the patient's mouth and teeth as is known in the art. The 3D mesh 110 includes a rendering of not only the patient's teeth and gum line, but also any brackets or other orthodontic appliances which are currently being used for the patient's orthodontic treatment.

The obtained 3D mesh 110 is first manipulated by a tooth segmentation and gumline detection module 116 as seen in FIG. 3 which automatically prompts a 3D segmentation step 201, followed by a generate trim line step 202. Specifically, the trim line in trim line step 202 is generated by selecting all vertices of the segmented teeth as well as vertices within a user-defined distance from the segmented teeth, usually around 2 or 3 millimeters. The trim line is then defined as the vertices at the border of the selection. Any unselected image data is then trimmed or subtracted from the 3D mesh 110 and then further smoothed or rounded in step 204. At this point, depending on the user's ultimate goal, the now trimmed and smoothed 3D mesh may further undergo a base or addition process in base step 204. After base step 204, any remaining artifacts or miscellaneous image data may be deleted from the 3D mesh 114 in clean step 205, thereby producing a clean image that is free from errors which may interfere with any subsequent manipulation by the user. Alternatively, instead of performing the base step 204, the trimmed and smoothed 3D mesh may directly be cleaned up or corrected via the clean step 205 as discussed above. Regardless, the end result of the trim and base method 200 is an updated or revised 3D mesh 118 which has had the image data related to any detected gumline effectively and efficiently trimmed, smoothed, and based, thereby providing a clean image of the patient's teeth and providing the user a means to easily adjust or change their prescription accordingly. It is important to note that the trim and base method 200 may be performed independently of the ABR method 100 discussed above, thereby permitting a user to trim and base a 3D mesh 110 without having to first digitally remove any image data relating to any brackets, and vice versa.

Once all automatic image manipulation has been completed, the user can then use the revised 3D mesh 114, 118 to create a new or different prescription for the patient by applying new set of brackets, bands, or attachments. Once applied, the user may send the revised 3D image to a lab where the corresponding attachments may be manufactured and then returned to the user who may then apply them to the patient.

The illustrated embodiments of the system and method can now be understood as an orthodontic or dental appliance removal system and method designed to efficiently and automatically remove orthodontic or dental appliances from an image of an intraoral scan, allowing doctors and other users access to review and update the prescriptions of their patients. The system allows for flexibility to make customizations based on the particular lab using the system. Since this is a web-based system, updates can be made on the fly and the doctors'data is stored via the cloud. In addition, the system and method can further refine the 3D model by cleaning up any remaining image artifacts, as well as adding or trimming elements to and from the 3D models which are subsequently used in the design of appliances.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A method for automatically creating a 3D dental model comprising:
uploading a first 3D image to an uploads database;
detecting image data corresponding to at least one appliance within the first 3D image;
generating a predicted displacement vector related to the image data corresponding to the at least one appliance;
inferring 3D image data calculated to approximate the surface of a tooth without the image data corresponding to the at least one appliance to create a second 3D image; and
saving the second 3D image to a processed database,
wherein the steps of detecting the image data, generating the predicted displacement vector, and inferring 3D image data calculated to approximate the surface of the tooth to create a second 3D image are automatically performed in sequence.

2. The method of claim 1, where uploading the first 3D image to an uploads database comprises providing a first 3D mesh corresponding to the first 3D image.

3. The method of claim 2, where detecting image data corresponding to the at least one appliance within the first 3D image comprises converting the first 3D mesh into a first point cloud comprising a plurality of points and a plurality of normal vectors.

4. The method of claim 3, where generating the predicted displacement vector related to the image data corresponding to the at least one appliance comprises generating a predicted displacement vector for each of the plurality of points and each of the plurality of normal vectors of the first point cloud.

5. The method of claim 4, where inferring 3D image data calculated to approximate the surface of the tooth without the image data corresponding to the at least one appliance to create the second 3D image commences only when at least one of the predicted displacement vectors comprises a non-zero value.

6. The method of claim 4, further comprising terminating the method when each of the predicted displacement vectors comprise a zero value.

7. The method of claim 3, where inferring 3D image data calculated to approximate the surface of the tooth without the image data corresponding to the at least one appliance to create the second 3D image comprises adding the predicted displacement vectors to the first point cloud to create a second point cloud.

8. The method of claim 7, further comprising removing any artifacts from the second point cloud.

9. The method of claim 7, further comprising converting the second point cloud to the second 3D image.

10. The method of claim 1, wherein saving the second 3D image to the processed database is performed automatically in sequence after inferring the 3D image data calculated to approximate the surface of the tooth without the image data corresponding to the at least one appliance.

11. The method of claim 8, wherein removing any artifacts from the second point cloud comprises defining an intersection between the second point cloud corresponding to the surface of the tooth without the image data corresponding to the at least one appliance and image data corresponding to a gumline of the patient within the second point cloud.

12. The method of claim 8 wherein removing any artifacts from the second point cloud comprises smoothening at least a portion of the second point cloud corresponding to the surface of the tooth without the image data corresponding to the at least one appliance.

13. The method of claim 1, wherein detecting the image data corresponding to the at least one appliance within the first 3D image comprises detecting image data corresponding to an orthodontic bracket.

14. The method of claim 1, further comprising transmitting metadata related to the first 3D image to a server in communication with the uploads database and the processed database.

15. The method of claim 14, further comprising sending the first 3D image from the server to a queue before detecting image data corresponding to at least one appliance within the first 3D image.

16. The method of claim 1, wherein uploading the first 3D image to the uploads database comprises automatically saving the first 3D image to a file storage within the uploads database.

17. The method of claim 1, wherein uploading the first 3D image to the uploads database comprises uploading a first STL file comprising the first 3D image.

18. The method of claim 1, wherein saving the second 3D image to the processed database comprises saving the second 3D image to a file storage within the processed database.

19. The method of claim 1, further comprising:
detecting image data corresponding to a gumline within the first 3D image; and
trimming the detected image data corresponding to the gumline,
wherein inferring 3D image data calculated to approximate the surface of the tooth without the image data corresponding to the at least one appliance to create a second 3D image comprises smoothening the image data corresponding to the gumline, and
wherein the steps of detecting, trimming, and smoothening the image data corresponding to the gumline within the first 3D image are automatically performed in sequence.

20. The method of claim 19, further comprising building a base to the image data corresponding to the gumline within the first 3D image.
